(19) United States
(12) Patent Application Publication
(10) Pub. No.: US 2023/0093983 A1
(43) Pub. Date: Mar. 30, 2023

(54) CONTROL METHOD AND DEVICE, TERMINAL AND STORAGE MEDIUM

(71) Applicant: Beijing Bytedance Network Technology Co., Ltd., Beijing (CN)

(72) Inventors: Chi FANG, Beijing (CN); Xiao Wang, Beijing (CN)

(21) Appl. No.: 18/073,567

(22) Filed: Dec. 2, 2022

Related U.S. Application Data
(63) Continuation of application No. PCT/CN2021/098464, filed on Jun. 4, 2021.

(30) Foreign Application Priority Data
Jun. 5, 2020 (CN) 202010507222.8

(51) Int. Cl. G06F 3/01; G06T 7/20; G06T 7/70

(52) U.S. Cl. CPC G06F 3/017; G06T 7/20; G06T 7/70; G06T 2207/30241; G06T 2207/30196; G06T 2207/10024

(57) ABSTRACT

The disclosure relates to the technical field of computers, in particular to a control method and device, terminal and storage medium. The control method provided by an embodiment of the disclosure includes: receiving an image, obtaining position information of a first part and gesture information of a second part of a user based on the image, determining a movement trajectory of a navigation indicator based on the position information of the first part, and determining a control command based on the gesture information of the second part, the control command being used for controlling a visual element to which the navigation indicator is directed.

### CROSS REFERENCE TO RELATED APPLICATIONS

The disclosure is a continuation of PCT application Ser. No. PCT/CN2021/098464, titled “CONTROL METHOD AND DEVICE, TERMINAL AND STORAGE MEDIUM”, filed on Jun. 4, 2021, which claims priority to Chinese Patent Application No. 202010507222.8, field on Jun. 5, 2020, and entitled “CONTROL METHOD, APPARATUS, TERMINAL AND STORAGE MEDIUM”, the entire contents of both of which are incorporated herein by reference.

### FIELD

The disclosure relates to the technical field of computers, in particular to a control method and device, terminal and storage medium.

### BACKGROUND

Smart TVs have replaced traditional TVs and can be equipped with a wide range of programmes and applications for users to choose from and watch. Smart TVs are controlled by a remote control, which usually has only four directional keys (up, down, left and right) to control the direction, making interaction inefficient and time-consuming.

### SUMMARY

This summary part is provided to introduce concepts in a brief form, and these concepts will be further described in the following specific embodiments. The summary is intended to neither identify key features or essential features of the claimed technical solutions nor limit the scope of the claimed technical solutions.

One aspect of the disclosure provides a control method, comprising:

receiving an image;

obtaining position information of a first part and gesture information of a second part of a user based on the image;

determining a movement trajectory of a navigation indicator based on the position information of the first part; and

determining a control command based on the gesture information of the second part, the control command being used for controlling a visual element to which the navigation indicator is directed.

Yet another aspect of the disclosure provides a control method, comprising.

receiving an image;

obtaining position information of a first part and gesture information of a second part of a user based on the image;

determining a controlled element to which a navigation indicator is directed based on the position information of the first part; and

determining a control command based on gesture information of the second part, the control command being used for controlling the controlled element to which the navigation indicator is directed.

Yet another aspect of the disclosure provides a control device, comprising:

at least one processor; and

at least one memory communicatively coupled to the at least one processor and storing instructions that upon execution by the at least one processor cause the device to:

receive an image;

obtain position information of a first part and gesture information of a second part of a user based on the image;

determine a movement trajectory of a navigation indicator based on the position information of the first part; and

determine a control command based on the gesture information of the second part, the control command being used for controlling a visual element to which the navigation indicator is directed.

Yet another aspect of the disclosure provides a control device, comprising:

at least one processor; and

at least one memory communicatively coupled to the at least one processor and storing instructions that upon execution by the at least one processor cause the device to:

receive an image;

obtain position information of a first part and gesture information of a second part of a user based on the image;

determine position information of a navigation indicator based on the position information of the first part, and/or, move a controlled element based on the position information of the first part and/or a preset gesture of the second part; and

determine a control command based on the gesture information of the second part, the control command being used for controlling the controlled element to which the navigation indicator is directed.

Yet another aspect of the disclosure provides a terminal, comprising:

at least one processor; and

at least one memory communicatively coupled to the at least one processor and storing instructions that upon execution by the at least one processor cause the terminal to perform the control method.

Yet another aspect of the disclosure provides a non-transitory computer storage medium, storing computer-readable instructions to perform the control method when the computer-readable instructions are executed by a computing device.

According to the control method provided by one or more embodiments of the disclosure, the movement trajectory of the navigation indicator is determined based on the position information of the first part, and the control command is determined based on the gesture information of the second part, so that determination of the control command is independent of determination of the position of the navigation indicator. On the one hand, the determination of the control command is based on static gesture information, while the determination of the position of the navigation indicator is based on dynamic position changes, thus facilitating the use of different characteristic algorithms to determine the above two processes respectively. On the other hand, the determination of the control command and the determination of the position of the navigation indicator are based on different body parts of the user, so that these determination processes do not interfere with each other, especially the shape of the contour of the first part does not change with the gesture of the second part, which can avoid the change of the gesture affecting the movement of the navigation indicator, and thus can improve the recognition accuracy of the user command.

### BRIEF DESCRIPTION OF THE DRAWINGS

The above and other features, advantages and aspects of embodiments of the disclosure will become more apparent in combination with the accompanying drawings and with reference to the following specific implementations. Throughout the accompanying drawings, the same or similar reference numerals represent the same or similar elements. It should be understood that the accompanying drawings are illustrative, and the originals and elements are not necessarily drawn to scale.

FIG. 1 illustrates a flow chart of a control method provided according to an embodiment of the disclosure.

FIG. 2 illustrates a schematic diagram of a scene of controlling a far-field display device according to a control method provided by an embodiment of the disclosure.

FIG. 3 illustrates a flow chart of a control method provided according to another embodiment of the disclosure.

FIG. 4 illustrates a schematic structural diagram of a control device provided according to one or more embodiments of the disclosure.

FIG. 5 is a schematic structural diagram of a terminal device for implementing an embodiment of the disclosure.

### DETAILED DESCRIPTION OF THE DISCLOSURE

The embodiments of the disclosure will be described in more detail below with reference to the accompanying drawings. Although some embodiments of the disclosure are shown in the accompanying drawings, it should be understood that the disclosure may be implemented in various forms and should not be construed as being limited to the embodiments described herein, on the contrary, these embodiments are provided for a more thorough and complete understanding of the disclosure. It should be understood that the accompanying drawings and embodiments of the disclosure are merely illustrative and are not to limit the scope of protection of the disclosure.

It should be understood that the steps described in the embodiments of the disclosure may be performed according to different orders and/or in parallel. In addition, the embodiments may include additional steps and/or omit the execution of the shown steps. The scope of the disclosure is not limited in this aspect.

The term “comprising” used herein and variants thereof means open-ended including, i.e., “including, but not limited to”. The term “based on” refers to “based at least in part on”. The term “one embodiment” represents “at least one embodiment”; the term “the other embodiment” represents “at least one additional embodiment”; and the term “some embodiments” represents “at least some embodiments”. Definitions of other terms will be provided in the description below.

It should be noted that the terms such as “first”, “second” and the like mentioned in the disclosure are merely intended to distinguish different devices, modules or units, rather than limiting an order of functions executed by these devices, modules or units or an interdependence among these devices, modules or units.

It should be noted that the modifications of “a” and “multiple” mentioned in the disclosure are illustrative, but are not restrictive. It should be understood by those skilled in the art that it should be understood as “one or more” unless otherwise specified in the context.

Names of messages or information interacted among a plurality of devices in the embodiments of the disclosure are merely for an illustrative purpose, rather than limiting the scope of these messages or information.

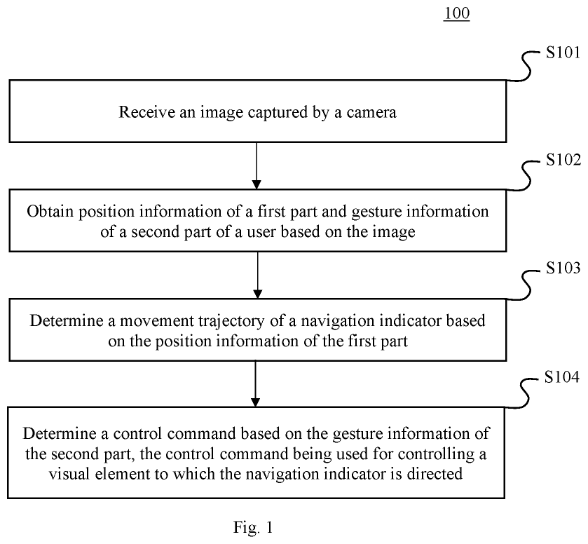

Referring to FIG. 1, which illustrates a flow chart of a control method 100 provided according to an embodiment of the disclosure, the method 100 may be used for a terminal device including but not limited to a far-field display device. The far-field display device refers to a display device that cannot be controlled by the user in a direct contact manner using body parts or other physical control devices such as a stylus, including but not limited to electronic devices such as TVs and conference screens. Specifically, the method 100 includes step S101 to step S104:

step S101, an image captured by a camera is received.

The camera may be built in or externally connected to the terminal device, which may send captured image data to the terminal device in real time for processing. Advantageously, the camera is set in a way that may face the user directly, so as to capture limb instructions sent by the user to the terminal device.

It needs to be noted that in other embodiments, images may further be received in other manners, or images captured or transmitted by other apparatuses are received, which is not limited in the disclosure.

Step S102, position information of a first part and gesture information of a second part of a user are obtained based on the image.

The first part and the second part are body parts of the user, such as one or more hands or arms. The position information of the first part is used to describe the position of the first part in the image, or the position of the first part relative to the controlled terminal device, and gesture information of the second part is used to describe the gesture of the second part, such as a hand gesture, etc.

Exemplarily, the position information of the first part and the gesture information of the second part of the user in the image may be obtained.

Step S103, a movement trajectory of a navigation indicator is determined based on the position information of the first part.

The navigation indicator may be used for selecting and controlling a visual element on a display interface. The navigation indicator may be represented by an icon, such as a cursor, or pointer, for example. and the navigation indicator may also be hidden while the visual element is highlighted or otherwise animated to indicate that the visual element is selected. The movement trajectory of the navigation indicator includes one or a group of moving vectors, which reflect a moving displacement and direction of the navigation indicator. The movement trajectory of the navigation indicator is determined by the position information of the first part of the user.

Exemplarily, a controlled element to which the navigation indicator is directed may be determined based on the position information of the first part, for example, a position and/or a movement trajectory of the navigation indicator on a controlled device is determined based on the position information of the first part relative to the controlled device, and the controlled element to which the navigation indicator is directed is determined based on the position and/or the movement trajectory.

Step S104, a control command is determined based on the gesture information of the second part, and the control command is used for controlling a visual element to which the navigation indicator is directed.

The control command is used to control or perform operation on the visual element to which the navigation indicator is directed, including clicking, touching, long pressing, zooming in, zooming out and rotating the visual element. In some embodiments, a mapping relation between the gesture information of each second part and the control command may be preset, so that the control command corresponding to the gesture information of the second part may be determined based on the mapping relation.

In this way, according to the control method provided by the embodiment of the disclosure, the movement trajectory of the navigation indicator is determined based on the position information of the first part, and the control command is determined based on the gesture information of the second part, so that determination of the control command is independent of determination of the position of the navigation indicator. On the one hand, the determination of the control command is based on static gesture information, while the determination of the position of the navigation indicator is based on dynamic position changes, thus facilitating the use of different characteristic algorithms to determine the above two processes respectively. Exemplarily, the determination of the control command may be based on the static gesture information, while the determination of the position of the navigation indicator is based on the dynamic position change information. Therefore, for the above two different calculation characteristics, the position information of the first part and the gesture information of the second part may be calculated by adopting computing modules with corresponding characteristics respectively, thereby improving the targeting of the information acquisition, the accuracy of the calculation and the utilization of the calculation resources. On the other hand, the determination of the control command and the determination of the position of the navigation indicator are based on different body parts of the user, which can make the determination processes of the two not affect each other, especially the shape of the contour of the first part does not change with the gesture of the second part, which can avoid the change of the gesture affecting the movement of the navigation indicator, and thus can improve the recognition accuracy of the user command.

In some embodiments, the first part and the second part belong to different body parts of the same user. There is no inclusive relationship between the first part and the second part, for example, when the second part is the hand, the first part can be the wrist, the elbow and not the fingers. In the embodiment of the disclosure, the movement trajectory of the navigation indicator and the control command are determined based on different body parts of the user respectively, so that the determination of the control command can be prevented from being affected when the user changes the position of the first part or the determination of the movement trajectory of the navigation indicator can be prevented from being affected when the user changes the gesture of the second part.

In some embodiments, the position of the second part can change with the position of the first part; and a position or gesture of the first part itself does not affect the gesture of the second part. In this way, the position of the second part can follow that of the first part, allowing the first and second parts to move in an interconnected space, avoiding the difficulty of capturing images of both the first and second parts due to the large spatial distance between them, which makes it difficult for the camera device to capture images of the first and second parts at the same time, thus increasing the success rate and ease of control of the controlled element using the first and second parts. In addition, changes in the position and/or gesture the first part do not affect the gesture of the second part, which also improves the accuracy of the control commands generated based on the attitude of the second part, allowing precise and easy control of the position of the navigation indicator and the issuing of control commands.

In some embodiments, the first part comprises a wrist, and the second part comprises a hand. In the embodiment of the disclosure, the wrist reflects the movement of the gesture accurately and steadily, and is less affected by changes in the gesture than the fingers or palm of the hand, allowing precise control of the movement of the navigation indicator. The movement of the wrist has no effect on the gesture, so that control commands can be given easily and precisely.

In some embodiments, step S102 further includes:

step A1, the position information of the first part of the user is obtained based on the image by means of a first computing module; and

step A2, the gesture information of the second part of the user is obtained based on the image by means of a second computing module.

The determination of the control command is based on the static gesture information, while the determination of the position of the navigation indicator is based on the dynamic position change. Therefore, in this embodiment, the position information of the first part and the gesture information of the second part are calculated by adopting the computing modules with different characteristics respectively, the pertinence of information acquisition can be improved, thus increasing the calculation accuracy and the utilization of calculation resources.

In some embodiments, the first computing module may run a first machine learning model, and the second computing module may run a second machine learning model. The first machine learning module and the second machine learning module are trained to reliably recognize and distinguish the first part and the second part of the user. By using a trained machine learning model to determine the position information of the first part and the gesture information of the second part, recognition accuracy can be improved and computational resources and hardware costs can be reduced.

In some embodiments, step S104 further includes:

step B1, if the gesture information of the second part conforms to a preset first gesture, a controlled element is controlled based on the gesture information of the second part.

The first gesture may include one or more preset hand gestures.

In some embodiments, step S104 further includes:

step B2, if the gesture information of the second part does not conform to the preset first gesture, the controlled element is not controlled based on the gesture information of the second part.

In some embodiments, when the gesture information of the second part does not conform to the preset first gesture, the navigation indicator is moved only based on the position information of the first part.

In some embodiments, step S102 further includes:

step C1, a key point of the first part in the image is determined; and

step C2, the position information of the first part is determined based on a position of the key point of the first part in the image.

In some embodiments, the method 100 further includes:

step S105, the visual element to which the navigation indicator is directed is controlled based on position information of the first part obtained based on at least two frames of target image. Exemplarily, the controlled element to which the navigation indicator is directed may be controlled based on the position change information of the first part obtained from the at least two frames of target image. The manner to control the controlled element to which the navigation indicator is directed includes, but not limited to controlling the controlled element to move on a controlled device by scrolling or moving, for example, scrolling or moving an application interface, an icon or other controls.

A method of determining the at least two frames of target image includes:

step D1, when the gesture information of the second part conforms to a preset second gesture, an image corresponding to the gesture information of the second part is taken as a target image; and

step D2, the at least two frames of target image are selected from a plurality of consecutive frames of target image.

According to one or more embodiments of the disclosure, the target image is an image whose gesture information conforms to the second gesture, and by translating the change in position of the first part into a scrolling effect of the visual element when the gesture information conforms to the second gesture, the user can control the navigation indicator to scroll the visual element, thereby enhancing interaction efficiency. The second gesture may include one or more preset hand gestures. Exemplarily, the controlled element may be moved based on the position information of the first part and/or the preset gesture of the second part, so that the controlled element to which the navigation indicator is directed is determined.

In some embodiments, step S105 further includes:

step E1, motion information of the first part is determined based on the position information of the first part obtained based on the at least two frames of target image; and

step E2, the visual element is scrolled based on the motion information of the first part.

The motion information of the first part includes one or more of the following: motion time of the first part, a motion speed of the first part, a displacement of the first part and a motion acceleration of the first part. In this embodiment, the motion information is determined based on the position information, and initial parameters and conditions required for scrolling the visual element can be obtained, so that relevant scrolling parameters of the visual element are determined.

In some embodiments, step E2 further includes:

whether the motion information of the first part meets a preset motion condition is determined; and

if yes, a scrolling direction and a scrolling distance of the visual element are determined based on the motion information of the first part.

In some embodiments, the second gesture is that a preset number of fingers splay out. Exemplarily, the second gesture comprises splaying five fingers of one hand apart. The scrolling commands usually require fast movement of the gesture, and with fast movement, splaying a preset number of fingers apart is easier to recognize than other gestures, thus improving recognition accuracy.

In some embodiments, step S103 further includes: if the gesture information of the second part conforms to a preset third gesture, the movement trajectory of the navigation indicator is determined based on the position information of the first part. The third gesture may include a plurality of preset hand gestures. In this embodiment, if the gesture information of the second part conforms to the preset third gesture, the movement trajectory of the navigation indicator is determined based on the position information of first part. For example, the navigation indicator is moved only based on the position of the first part when the hand conforming to the preset hand gesture, which prevent the user from unintentionally moving the first part to cause the navigation indicator to move by mistake.

In some embodiment, step S103 further includes: the movement trajectory of the navigation indicator is determined based on the position information of the first part obtained from spaced images. In the embodiment of the disclosure, in order to prevent jitter of the navigation indicator caused by the inevitable shaking of the user when waving the first part, the movement trajectory of the navigation indicator can be determined based on the position information of the first part obtained from the spaced images, which can reduce jitter of the navigation indicator compared to determining the movement trajectory of the navigation indicator based on the position change of the first part determined from the continuous images. The number of frames between the two spaced images may be predetermined or dynamically adjusted. Exemplarily, the change in position of the first part in a plurality of frames in chronological order (e.g., a plurality of consecutive frames), or the coordinates of the navigation indicator transformed by the change in position, can be fitted to a smooth curve from which the trajectory of the navigation indicator can be determined

In some embodiments, the camera is an RGB camera. The method 100 further includes a color space preprocessing step, which performs HSV color space processing on image data, so as to convert a color space of the image data into an HSV color space. The RGB camera usually uses three independent CCD sensors to obtain three color signals, which can capture very accurate color images and the accuracy of extraction and recognition of gesture features of the second part and the key point features of the first part can be improved. However, since RGB mode images are not conducive to skin color segmentation, according to the embodiment of the disclosure, color space preprocessing is further performed on the image data captured by the camera, the color space of the image data is converted into the HSV color space, so that the subsequent recognition and extraction of the gesture features of the second part and the key point features of the first part can be more accurate.

In some embodiments, the first machine learning model comprises a convolutional neural networks (CNN) model. The method 100 further includes a step of binarization preprocessing which preforms binarization processing on the image data to obtain binarization image data and a step of white balance preprocessing which performs white balance processing on the image data. Convolutional neural networks are input-to-output mappings that learn mapping relationships between inputs and outputs without the need for any precise mathematical expressions between inputs and outputs, and can be trained by known patterns to have the ability to map between input-output pairs, which are used to recognize the displacement of two-dimensional shapes with high accuracy. Therefore, adopting the convolutional neural network model to obtain the position of the first part has high accuracy. Further, the binarization of the image makes it possible to significantly reduce the amount of data of the image data to highlight the gesture contour of the second part, while the white balance processing corrects the lighting conditions of the image data so that the subsequent identification and extraction of the gesture features of the second part and the key point features of the first part can be more accurate.

In some embodiments, step S103 further includes: a final movement trajectory of the navigation indicator is determined by adopting a filtering algorithm and an anti-shake algorithm based on the position information of the first part. The filtering algorithm may include a Kalman filtering algorithm, and the anti-shake algorithm may include a moving average algorithm. In the embodiment of the disclosure, the position change of the key point features of the first part or the navigation indicator coordinate change determined by the position change is processed by adopting the filtering algorithm and the anti-shake algorithm, so that the movement trajectory of the navigation indicator can be smoother, and jitter of the navigation indicator is prevented.

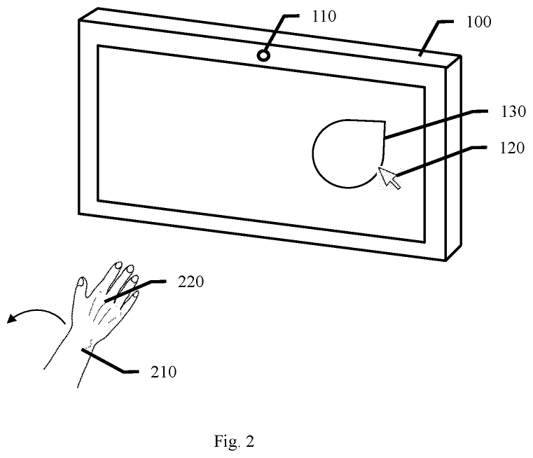

FIG. 2 illustrates a schematic diagram of a scene of controlling a far-field display device based on a control method provided by an embodiment of the disclosure. The far-field display device 100 has a camera 110 which is configured to capture an image within a certain region in front of the far-field display device 100. According to the control method provided by one or more embodiments of the disclosure, a user (not shown) may wave wrist 210 to move a navigation indicator 120 displayed on the far field display device 100, and performs a gesture with hand 220 to give a specific control command to a visual element 130 to which the navigation indicator 120 is directed.

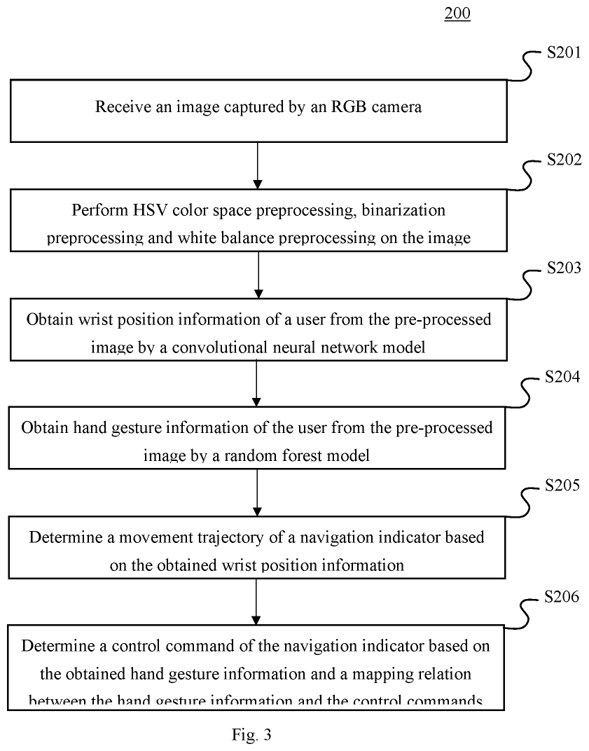

Referring to FIG. 3, which illustrates a flow chart of a control method 200 provided based on another embodiment of the disclosure, and the method 200 includes step S201 to step S206:

step S201, an image captured by an RGB camera is received;

step S202, HSV color space preprocessing, binarization preprocessing and white balance preprocessing are performed on the image;

step S203, wrist position information of a user is obtained from the pre-processed image by a convolutional neural network model;

step S204, hand gesture information of the user is obtained from the pre-processed image by a random forest model. Random forest is a machine learning algorithm that is very tolerant of noise and outliers, does not overfit, and is highly accurate in extracting and identifying a wide range of second part gesture features;

step S205, a movement trajectory of a navigation indicator is determined based on the obtained wrist position information; and

step S206, a control command of the navigation indicator is determined based on the obtained hand gesture information and a mapping relation between the hand gesture information and the control commands. The control command is used for controlling a visual element to which the navigation indicator is directed.

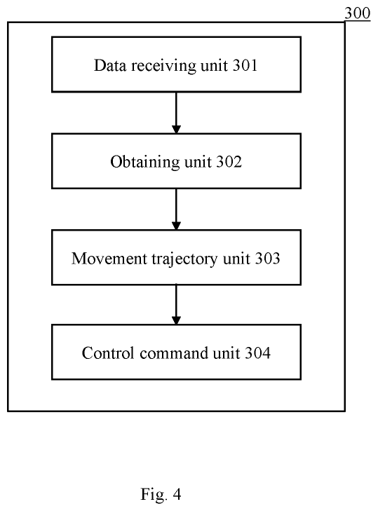

Accordingly, FIG. 4 illustrates a schematic diagram of the structure of a control method device 300 provided in accordance with an embodiment of the disclosure. The device 300 comprises:

a data receiving unit 301, configured to receive an image;

an obtaining unit 302, configured to obtain position information of a first part and gesture information of a second part of a user based on the image;

a movement trajectory unit 303, configured to determine a movement trajectory of a navigation indicator based on the position information of the first part; and

a control command unit 304, configured to determine a control command based on the gesture information of the second part, the control command being used for controlling a visual element to which the navigation indicator is directed.

According to the control method device provided by one or more embodiments of the disclosure, the movement trajectory of the navigation indicator is determined based on the position information of the first part, and the control command is determined based on the gesture information of the second part, so that determination of the control command is independent of determination of the position of the navigation indicator. On the one hand, the determination of the control command is based on static gesture information, while the determination of the position of the navigation indicator is based on dynamic position changes, thus facilitating the use of different characteristic algorithms to determine the above two processes respectively. Exemplarily, the determination of the control command may be based on the static gesture information, while the determination of the position of the navigation indicator is based on the dynamic position change information. Therefore, for the above two different calculation characteristics, the position information of the first part and the gesture information of the second part may be calculated by adopting computing modules with corresponding characteristics respectively, thereby improving the targeting of the information acquisition, the accuracy of the calculation and the utilization of the calculation resources. On the other hand, the determination of the control command and the determination of the position of the navigation indicator are based on different body parts of the user, so that these determination processes do not interfere with each other, especially the shape of the contour of the first part does not change with the gesture of the second part, which can avoid the change of the gesture affecting the movement of the navigation indicator, and thus can improve the recognition accuracy of the user command.

It needs to be noted that in other embodiments, images may further be received in other manners, or images captured or transmitted by other apparatuses are received, which is not limited in the disclosure.

For the embodiment of the device, which basically corresponds to the method embodiment, it is sufficient to refer to the description of the method embodiment for the relevant parts. The embodiments of the device described above are merely schematic, where the modules illustrated as separate modules may or may not be separate. Some or all of these modules may be selected according to practical needs to achieve the purpose of this embodiment solution. It can be understood and implemented without creative work by a person of ordinary skill in the art.

In some embodiments, the obtaining unit 302 is further configured to obtain the position information of the first part of the user based on the image by means of a first computing module and obtain the gesture information of the second part of the user based on the image by means of a second computing module.

The determination of the control command is based on the static gesture information, while the determination of the position of the navigation indicator is based on the dynamic position change. Therefore, in this embodiment, the position information of the first part and the gesture information of the second part are calculated by adopting the computing modules with different characteristics respectively, the pertinence of information acquisition can be improved, thus increasing the calculation accuracy and the utilization of calculation resources.

In some embodiments, the first computing module may run a first machine learning model, and the second computing module may run a second machine learning model. The first machine learning module and the second machine learning module are trained to reliably recognize and distinguish the first part and the second part of the user. By using a trained machine learning model to determine the position information of the first part and the gesture information of the second part, recognition accuracy can be improved and computational resources and hardware costs can be reduced.

In some embodiments, the control command unit 304 is further configured to control a controlled element based on the gesture information of the second part if the gesture information of the second part conforms to a preset first gesture.

The first gesture may include one or more preset hand gestures.

In some embodiments, the control command unit 304 is further configured to not control the controlled element based on the gesture information of the second part if the gesture information of the second part does not conform to the preset first gesture

In some embodiments, when the gesture information of the second part does not conform to the preset first gesture, the navigation indicator is moved only based on the position information of the first part.

In some embodiments, the obtaining unit 302 further comprises:

key point determination sub-unit, configured to determine a key point of the first part in the image; and

position determination sub-unit, configured to determine the position information of the first part based on a position of the key point of the first part in the image.

In some embodiments, the device 300 further includes scrolling unit, configured to scroll the visual element to which the navigation indicator is directed based on position information of the first part obtained based on at least two frames of target image.

In some embodiments, the scrolling unit further includes:

target image determination sub-unit, configured to take, if the gesture information of the second part conforms to a preset second gesture, an image corresponding to the gesture information of the second part as a target image; and

target image selection sub-unit, configured to select the at least two frames of target image from a plurality of consecutive frames of target image.

According to one or more embodiments of the disclosure, the target image is an image whose gesture information conforms to the second gesture, and by translating the change in position of the first part into a scrolling effect of the visual element when the gesture information conforms to the second gesture, the user can control the navigation indicator to scroll the visual element, thereby enhancing interaction efficiency. The second gesture may include one or more preset hand gestures.

In some embodiments, the scrolling unit further includes:

motion information sub-unit, configured to determine motion information of the first part based on the position information of the first part obtained based on the at least two frames of target image; and

scrolling sub-unit, configured to scroll the visual element based on the motion information of the first part.

The motion information of the first part includes one or more of the following: motion time of the first part, a motion speed of the first part, a displacement of the first part and a motion acceleration of the first part. In this embodiment, the motion information is determined based on the position information, and initial parameters and conditions required for scrolling the visual element can be obtained, so that relevant scrolling parameters of the visual element are determined.

In some embodiments, the scrolling sub-unit is further configured to determine whether the motion information of the first part meets a preset motion condition, and if yes, to determine a scrolling direction and a scrolling distance of the visual element based on the motion information of the first part

In some embodiments, the second gesture comprises splaying five fingers of one hand apart. The scrolling commands usually require fast movement of the gesture, and with fast movement, splaying five fingers apart is easier to recognize than other gestures, thus improving recognition accuracy.

In some embodiments, the movement trajectory unit 303 is further configured to determine the movement trajectory of the navigation indicator based on the position information of the first part, if the gesture information of the second part conforms to a preset third gesture, The third gesture may include a plurality of preset hand gestures. In this embodiment, if the gesture information of the second part conforms to the preset third gesture, the movement trajectory of the navigation indicator is determined based on the position information of first part. For example, the navigation indicator is moved only based on the position of the first part when the hand conforming to the preset hand gesture, which prevent the user from unintentionally moving the first part to cause the navigation indicator to move by mistake.

In some embodiments, the movement trajectory unit 303 is further configured to determine the movement trajectory of the navigation indicator based on the position information of the first part obtained from spaced images. In order to prevent jitter of the navigation indicator caused by the inevitable shaking of the user when waving the first part, the movement trajectory of the navigation indicator can be determined based on the position information of the first part obtained from the spaced images, which can reduce jitter of the navigation indicator compared to determining the movement trajectory of the navigation indicator based on the position change of the first part determined from the continuous images. Exemplarily, the change in position of the first part in a plurality of frames in chronological order (e.g., a plurality of consecutive frames), or the coordinates of the navigation indicator transformed by the change in position, can be fitted to a smooth curve from which the trajectory of the navigation indicator can be determined

In some embodiments, the camera is an RGB camera. The device 300 further includes a color space preprocessing unit configured to perform HSV color space processing on image data, so as to convert a color space of the image data into an HSV color space. The RGB camera usually uses three independent CCD sensors to obtain three color signals, which can capture very accurate color images and the accuracy of extraction and recognition of gesture features of the second part and the key point features of the first part can be improved. However, since RGB mode images are not conducive to skin color segmentation, according to the embodiment of the disclosure, color space preprocessing is further performed on the image data captured by the camera, the color space of the image data is converted into the HSV color space, so that the subsequent recognition and extraction of the gesture features of the second part and the key point features of the first part can be more accurate.

In some embodiments, the first machine learning model comprises a convolutional neural networks (CNN) model. The device 300 further includes a binarization and white balance preprocessing unit configured to preform binarization processing and white balance processing on the image data. Convolutional neural networks are input-to-output mappings that learn mapping relationships between inputs and outputs without the need for any precise mathematical expressions between inputs and outputs, and can be trained by known patterns to have the ability to map between input-output pairs, which are used to recognize the displacement of two-dimensional shapes with high accuracy. Therefore, adopting the convolutional neural network model to obtain the position of the first part has high accuracy. Further, the binarization of the image makes it possible to significantly reduce the amount of data of the image data to highlight the gesture contour of the second part, while the white balance processing corrects the lighting conditions of the image data so that the subsequent identification and extraction of the gesture features of the second part and the key point features of the first part can be more accurate.

In some embodiments, the movement trajectory unit 303 is further configured to determine a final movement trajectory of the navigation indicator by adopting a filtering algorithm and an anti-shake algorithm based on the position information of the first part. The filtering algorithm may include a Kalman filtering algorithm, and the anti-shake algorithm may include a moving average algorithm. In the embodiment of the disclosure, the position change of the key point features of the first part or the navigation indicator coordinate change determined by the position change is processed by adopting the filtering algorithm and the anti-shake algorithm, so that the movement trajectory of the navigation indicator can be smoother, and the jitter of the navigation indicator is prevented.

Correspondingly, the disclosure further provides a terminal comprising:

at least one processor;

and at least one memory communicatively coupled to the at least one processor and storing instructions that upon execution by the at least one processor cause the terminal to perform the foregoing control method.

Correspondingly, the disclosure further provides a non-transitory computer storage medium storing computer-readable instructions to perform the foregoing control method when the computer-readable instructions are executed by a computing device.

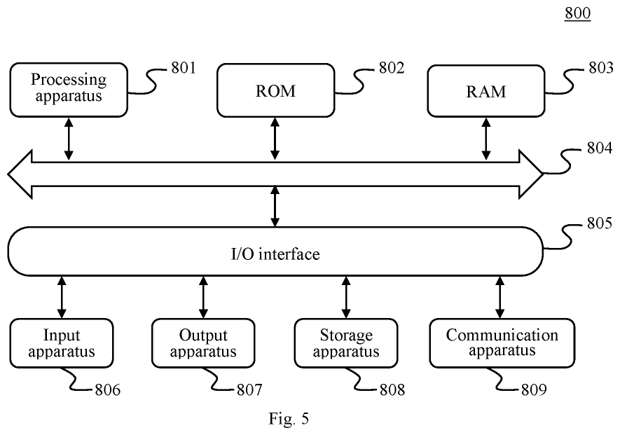

Referring now to FIG. 5, a structural schematic diagram of terminal equipment 900 suitable for implementing an embodiment of the disclosure is shown. The terminal equipment in the embodiment of the present disclosure can include, but is not limited to, mobile terminals such as a mobile phone, a notebook computer, a digital broadcast receiver, a personal digital assistant (PDA), a Pad, a portable media player (PMP) and a vehicle-mounted terminal (e.g., vehicle-mounted navigation terminal), and fixed terminals such as a digital TV and a desktop computer. The terminal equipment shown in FIG. 5 is only an example, and should not bring any restrictions on the functions and application scope of the embodiments of the present disclosure.

As shown in FIG. 5, the terminal equipment 900 can comprise a processing device (e.g., central processing unit, graphics processor, etc.) 901, which can perform various appropriate actions and processing according to a program stored in a read-only memory (ROM) 902 or a program loaded into a random access memory (RAM) 903 from a storage device 908. In the RAM 903, various programs and data required for the operation of the terminal equipment 900 are also stored. The processing device 901, the ROM 902, and the RAM 903 are connected through a bus 904. An Input/Output (I/O) interface 905 is also connected to the bus 904.

Generally, the following devices can be connected to the I/O interface 905: an input device 906 such as a touch screen, a touch pad, a keyboard, a mouse, a camera, a microphone, an accelerometer and a gyroscope; an output device 907 such as a liquid crystal display (LCD), a speaker and a vibrator; a storage device 908 such as a magnetic tape and a hard disk; and a communication device 909. The communication device 909 can allow the terminal equipment 900 to perform wireless or wired communication with other equipment to exchange data. Although FIG. 5 shows the terminal equipment 900 with various devices, it should be understood that it is not required to implement or provide all the devices shown. More or fewer devices may alternatively be implemented or provided.

Particularly, according to the embodiments of the disclosure, the processes described above with reference to the flowcharts may be implemented as computer software programs. For example, the embodiments of the disclosure comprise a computer program product comprising a computer program carried by a computer-readable medium, and the computer program contains program codes for executing the method shown in the flowcharts. In such embodiment, the computer program can be downloaded and installed from a network through the communication device 909, or installed from the storage device 908, or installed from the ROM 902. When the computer program is executed by the processing device 901, the above functions defined in the method of the embodiments of the disclosure are executed.

It should be noted that the above-mentioned computer-readable medium can be a computer-readable signal medium or a computer-readable storage medium or any combination of the two. The computer-readable storage medium may be, for example, but not limited to, an electrical, magnetic, optical, electromagnetic, infrared or semiconductor system, device or component, or any combination of the above. More specific examples of the computer-readable storage medium may include, but are not limited to, an electrical connector with one or more wires, a portable computer disk, a hard disk, an RAM, an ROM, an electrically erasable programmable read only memory (EPROM) or flash memory, an optical fiber, a portable compact disc read-only memory (CD-ROM), an optical storage device, a magnetic storage device, or any suitable combination of the above. In the disclosure, the computer-readable storage medium can be any tangible medium containing or storing a program, which can be used by or in combination with an instruction execution system, device or component. In the disclosure, the computer-readable signal medium can comprise a data signal propagated in a baseband or as part of a carrier wave, in which computer-readable program codes are carried. This propagated data signal can take various forms, including but not limited to an electromagnetic signal, an optical signal or any suitable combination of the above. The computer-readable signal medium can also be any computer-readable medium other than the computer-readable storage medium, and the computer-readable signal medium can send, propagate or transmit the program for use by or in connection with the instruction execution system, device or component. The program codes contained in the computer-readable medium can be transmitted by any suitable medium, including but not limited to electric wire, optical cable, radio frequency (RF) or any suitable combination of the above.

In some embodiments, the client and the server can use any currently known or future developed network protocols such as HTTP (Hyper Text Transfer Protocol) to communicate, and can communicate with any form or medium digital data communications (e.g., communications networks) interconnected. Examples of communication networks include local area networks (“LAN”), wide area networks (“WAN”), the Internet, and peer-to-peer networks (e.g., ad hoc peer-to-peer networks), as well as any currently known or future developed network.

The computer-readable medium can be included in the terminal equipment, and can also exist alone without being assembled into the terminal equipment.

The computer-readable medium stores one or more programs that upon execution by the terminal cause the terminal to: receive an image, obtain position information of a first part and gesture information of a second part of a user based on the image, determine a movement trajectory of a navigation indicator based on the position information of the first part, and determine a control command based on the gesture information of the second part, the control command being used for controlling a visual element to which the navigation indicator is directed.

Or, the computer-readable medium stores one or more programs that upon execution by the terminal cause the terminal to: receiving an image, obtaining position information of a first part and gesture information of a second part of a user based on the image, determining a controlled element to which a navigation indicator is directed based on the position information of the first part, and determine a control command based on gesture information of the second part, the control command being used for controlling the controlled element to which the navigation indicator is directed.

Computer program codes for performing the operations of the disclosure can be written in one or more programming languages or a combination thereof, including object-oriented programming languages such as Java, Smalltalk, C++, and conventional procedural programming languages such as “C” language or similar programming languages. The program code can be completely or partially executed on a user computer, executed as an independent software package, partially executed on a user computer and partially executed on a remote computer, or completely executed on a remote computer or server. In a case involving a remote computer, the remote computer can be connected to a user computer through any kind of network including a local area network (LAN) or a wide area network (WAN), or can be connected to an external computer (e.g., connected through the Internet using an Internet service provider).

The flowcharts and block diagrams in the drawings show the architectures, functions and operations of possible implementations of systems, methods and computer program products according to various embodiments of the disclosure. In this regard, each block in the flowchart or block diagram can represent a module, a program segment or part of a code that contains one or more executable instructions for implementing a specified logical function. It should also be noted that in some alternative implementations, the functions noted in the blocks can also occur in a different order from those noted in the drawings. For example, two consecutive blocks can actually be executed in substantially parallel, and sometimes they can be executed in reverse order, depending on the functions involved. It should also be noted that each block in the block diagrams and/or flowcharts, and combinations of blocks in the block diagrams and/or flowcharts, can be implemented with dedicated hardware-based systems that perform specified functions or actions, or can be implemented with combinations of dedicated hardware and computer instructions.

The modules or units described in the embodiments of the disclosure can be implemented by software or hardware. The name of a module or unit does not constitute a limitation to the module or unit itself under certain circumstances. For example, the obtaining unit can also be described as “a unit for obtaining position information of a first part and gesture information of a second part of a user based on the image”.

The functions described herein above may be performed, at least in part, by one or more hardware logic components. For example, exemplary types of hardware logic components that may be used include: Field Programmable Gate Arrays (FPGAs), Application Specific Integrated Circuits (ASICs), Application Specific Standard Products (ASSPs), Systems on Chips (SOCs), Complex Programmable Logical Devices (CPLDs) and etc.

In the context of the present disclosure, a machine-readable medium may be a tangible medium that may contain or store programs for use by or in combination with an instruction execution system, device, or device. The machine-readable medium may be a machine-readable signal medium or a machine-readable storage medium. Machine readable media may include, but are not limited to, electronic, magnetic, optical, electromagnetic, infrared, or semiconductor systems, devices or devices, or any suitable combination of the above. More specific examples of machine-readable storage media will include electrical connections based on one or more lines, portable computer disks, hard disks, random access memory (RAM), read only memory (ROM), erasable programmable read only memory (EPROM or flash memory), optical fibers, portable compact disk read only memory (CD-ROM), optical storage devices, magnetic storage devices or any suitable combination of the above.

In some embodiments, the disclosure provides a control method, comprising: receiving an image, obtaining position information of a first part and gesture information of a second part of a user based on the image, determining a movement trajectory of a navigation indicator based on the position information of the first part, and determining a control command based on the gesture information of the second part, the control command being used for controlling a visual element to which the navigation indicator is directed.

In some embodiments, the first part and the second part belong to different body parts of the user.

In some embodiments, a position of the second part can change with a position of the first part, and/or wherein a gesture of the second part is independent of a position and/or gesture of the first part.

In some embodiments, the first part comprises a wrist, and wherein the second part comprises a hand.

In some embodiments, the obtaining position information of a first part and gesture information of a second part of a user based on the image, comprises: obtaining, by a first computing module, the position information of the first part of the user based on the image; and obtaining, by a second computing module, the posture information of the second part of the user based on the image.

In some embodiments, the first computing module is configured to run a first machine learning model, and wherein the second computing module is configured to run a second machine learning model.

In some embodiments, the visual element is controlled based on the gesture information of the second part if the gesture information of the second part conforms to a preset first gesture.

In some embodiments, the visual element is not controlled based on the gesture information of the second part if the gesture information of the second part does not conform to the preset first gesture.

In some embodiments, the obtaining position information of a first part and gesture information of a second part of a user based on the image, comprises: determining a key point of the first part in the image; and determining the position information of the first part based on a position of the key point of the first part in the image.

In some embodiments, the control method further comprises: controlling the visual element to which the navigation indicator is directed based on the position information of the first part obtained based on at least two frames of target image, wherein a method of determining the at least two frames of target image comprises: taking, if the gesture information of the second part conforms to a preset second gesture, an image corresponding to the gesture information of the second part as the target image; and selecting the at least two frames of target image from a plurality of consecutive frames of target image.

In some embodiments, the controlling the visual element to which the navigation indicator is directed based on the position information of the first part obtained based on at least two frames of target image, comprises: determining motion information of the first part based on the position information of the first part obtained based on the at least two frames of target image; and controlling the visual element based on the motion information of the first part.

In some embodiments, the motion information of the first part comprises one or more of the following: motion time of the first part, a motion speed of the first part, a displacement of the first part and a motion acceleration of the first part.

In some embodiments, the controlling the visual element based on the motion information of the first part, comprises: determining whether the motion information of the first part meets a preset motion condition; and determining a scrolling direction and a scrolling distance of the visual element based on the motion information of the first part if the motion information of the first part meets a preset motion condition.

In some embodiments, the controlling the visual element to which the navigation indicator is directed, comprises: scrolling or moving the visual element.

In some embodiments, the second gesture comprises splaying a preset number of fingers apart.

In some embodiments, the determining a movement trajectory of a navigation indicator based on the position information of the first part, comprises: determining the movement trajectory of the navigation indicator based on the position information of the first part if the gesture information of the second part conforms to a preset third gesture.

In some embodiments, the determining a movement trajectory of a navigation indicator based on the position information of the first part, comprises: determining the movement trajectory of the navigation indicator based on the position information of the first part obtained from spaced images.

In some embodiments, the receiving an image comprises: receiving an image captured by a camera.

In some embodiments, the camera comprises an RGB camera, and wherein the control method further comprises: performing HSV color space processing on the image to convert a color space of the image into an HSV color space.

In some embodiments, the first machine learning model comprises a convolutional neural network model, and the control method further comprises: preforming binarization processing and white balance processing on the image.

In some embodiments, the determining a movement trajectory of a navigation indicator based on the position information of the first part, comprises: determining, based on the position information of the first part, a final movement trajectory of the navigation indicator by adopting a filtering algorithm and an anti-shake algorithm.

In some embodiments, the obtaining position information of a first part and gesture information of a second part of a user based on the image, comprises: obtaining the position information of the first part and the gesture information of the second part of the user in the image.

In some embodiments, the disclosure provides a control device, comprising: a data receiving unit, configured to receive an image; an obtaining unit, configured to obtain position information of a first part and gesture information of a second part of a user based on the image; a movement trajectory unit, configured to determine a movement trajectory of a navigation indicator based on the position information of the first part; and a control command unit, configured to determine a control command based on the gesture information of the second part, the control command being used for controlling a visual element to which the navigation indicator is directed.

In some embodiments, the disclosure provides a terminal, comprising: at least one processor; and at least one memory communicatively coupled to the at least one processor and storing instructions that upon execution by the at least one processor cause the terminal to perform the foregoing control method.

In some embodiments, the disclosure provides a computer storage medium, storing computer-readable instructions to perform the foregoing control method when the computer-readable instructions are executed by a computing device.

The above description is only a preferred embodiment of the disclosure and an explanation of the applied technical principles. Those skilled in the art should understand that the scope of disclosure involved in this disclosure is not limited to the technical solutions formed by the specific combination of the above technical features, and should also cover other technical solutions formed by any combination of the above technical features or their equivalent features without departing from the above disclosed concept. For example, the above-mentioned features and the technical features disclosed in (but not limited to) the disclosure having similar functions are replaced with each other to form a technical solution.

In addition, although the operations are depicted in a specific order, it should not be understood as requiring these operations to be performed in the specific order shown or performed in a sequential order. Under certain circumstances, multitasking and parallel processing may be advantageous. Likewise, although several specific implementation details are included in the above discussion, these should not be construed as limiting the scope of the disclosure. Certain features that are described in the context of separate embodiments may also be implemented in combination in a single embodiment. Conversely, various features that are described in the context of a single embodiment may also be implemented in multiple implementations individually or in any suitable sub-combination.

Although the subject matter has been described in a language specific to structural features and/or logical actions of the method, it should be understood that the subject matter defined in the appended claims is not necessarily limited to the specific features or actions described above. On the contrary, the specific features and actions described above are merely exemplary forms of implementing the claims.

What is claimed is:

1. A control method, comprising:
receiving an image;
obtaining position information of a first part and gesture information of a second part of a user based on the image;
determining a movement trajectory of a navigation indicator based on the position information of the first part; and
determining a control command based on the gesture information of the second part, the control command being used for controlling a visual element to which the navigation indicator is directed.

2. The control method of claim 1, wherein the first part and the second part belong to different body parts of the user, and/or wherein there is no inclusive relationship between the first part and the second part.

3. The control method of claim 1, wherein a change in the position of the first part reflects a change in the position of the second part, and/or wherein a gesture of the second part is independent of a position and/or gesture of the first part.

4. The control method of claim 1, wherein the first part comprises a wrist, and wherein the second part comprises a hand.

5. The control method of claim 1, wherein the obtaining position information of a first part and gesture information of a second part of a user based on the image, comprises:
obtaining, by a first computing module, the position information of the first part of the user based on the image; and
obtaining, by a second computing module, the posture information of the second part of the user based on the image.

6. The control method of claim 5, wherein the first computing module is configured to run a first machine learning model, and wherein the second computing module is configured to run a second machine learning model.

7. The control method of claim 1, wherein the visual element is controlled based on the gesture information of the second part if the gesture information of the second part conforms to a preset first gesture, or wherein the visual element is not controlled based on the gesture information of the second part if the gesture information of the second part does not conform to the preset first gesture.

8. The control method of claim 1, further comprising:
controlling the visual element to which the navigation indicator is directed based on the position information of the first part obtained based on at least two frames of target image,
wherein a method of determining the at least two frames of target image comprises:
taking, if the gesture information of the second part conforms to a preset second gesture, an image corresponding to the gesture information of the second part as the target image; and
selecting the at least two frames of target image from a plurality of consecutive frames of target image.

9. The control method of claim 8, wherein the controlling the visual element to which the navigation indicator is directed based on the position information of the first part obtained based on at least two frames of target image, comprises:
determining motion information of the first part based on the position information of the first part obtained based on the at least two frames of target image; and
controlling the visual element based on the motion information of the first part.

10. The control method of claim 9, wherein the motion information of the first part comprises one or more of the following: motion time of the first part, a motion speed of the first part, a displacement of the first part and a motion acceleration of the first part, or
wherein the controlling the visual element based on the motion information of the first part, comprises: determining whether the motion information of the first part meets a preset motion condition; and determining a scrolling direction and a scrolling distance of the visual element based on the motion information of the first part if the motion information of the first part meets a preset motion condition.

11. The control method of claim 8 wherein the controlling the visual element to which the navigation indicator is directed, comprises: scrolling or moving the visual element, or
wherein the second gesture comprises splaying a preset number of fingers apart.

12. The control method of claim 1, wherein the determining a movement trajectory of a navigation indicator based on the position information of the first part, comprises: determining the movement trajectory of the navigation indicator based on the position information of the first part if the gesture information of the second part conforms to a preset third gesture, or
wherein the determining a movement trajectory of a navigation indicator based on the position information of the first part, comprises: determining the movement trajectory of the navigation indicator based on the position information of the first part obtained from spaced images.

13. The control method of claim 1, wherein the receiving an image comprises: receiving an image captured by a camera.

14. The control method of claim 13, wherein the camera comprises an RGB camera, and wherein the control method further comprises: performing HSV color space processing on the image to convert a color space of the image into an HSV color space, or
wherein the control method further comprises: preforming binarization processing and white balance processing on the image, or
wherein the determining a movement trajectory of a navigation indicator based on the position information of the first part, comprises: determining, based on the position information of the first part, a final movement trajectory of the navigation indicator by adopting a filtering algorithm and an anti-shake algorithm.

15. The control method of claim 1, wherein the obtaining position information of a first part and gesture information of a second part of a user based on the image, comprises: obtaining the position information of the first part and the gesture information of the second part of the user in the image; or
wherein the determining a movement trajectory of a navigation indicator based on the position information of the first part, comprises: determining a movement trajectory of a navigation indicator on a controlled device based on position information of the first part relative to the controlled device, and wherein the control command is used for controlling a visual element to which the navigation indicator is directed on the controlled device.

16. A control method, comprising:
receiving an image;
obtaining position information of a first part and gesture information of a second part of a user based on the image;
determining a controlled element to which a navigation indicator is directed based on the position information of the first part; and
determining a control command based on gesture information of the second part, the control command being used for controlling the controlled element to which the navigation indicator is directed.

17. The control method of claim 16, wherein the determining a controlled element to which a navigation indicator is directed based on the position information of the first part, comprises:
determining a position and/or a movement trajectory of the navigation indicator on a controlled device based on position information of the first part relative to the controlled device, and determining the controlled element to which the navigation indicator is directed based on the position and/or the movement trajectory; and/or
controlling the controlled element to which the navigation indicator is directed based on position change information of the first part obtained from at least two frames of target image.

18. The control method of claim 17, wherein the controlling the controlled element to which the navigation indicator is directed, comprises:
controlling the movement of the controlled element on the controlled device.

19. A control device, comprising:
at least one processor; and
at least one memory communicatively coupled to the at least one processor and storing instructions that upon execution by the at least one processor cause the device to:
receive an image;
obtain position information of a first part and gesture information of a second part of a user based on the image;
determine a movement trajectory of a navigation indicator based on the position information of the first part; and
determine a control command based on the gesture information of the second part, the control command being used for controlling a visual element to which the navigation indicator is directed.

20. A control device, comprising:
at least one processor; and
at least one memory communicatively coupled to the at least one processor and storing instructions that upon execution by the at least one processor cause the device to:
receive an image;
obtain position information of a first part and gesture information of a second part of a user based on the image;
determine position information of a navigation indicator based on the position information of the first part, and/or move a controlled element based on the position information of the first part and/or a preset gesture of the second part; and
determine a control command based on the gesture information of the second part, the control command being used for controlling the controlled element to which the navigation indicator is directed.
